(19) United States
(12) Patent Application Publication
(10) Pub. No.: US 2017/0082957 A1
(43) Pub. Date: Mar. 23, 2017

(54) SELF-HEAT-GENERATING FIXING ROLLER

(71) Applicants: SUMITOMO ELECTRIC INDUSTRIES, LTD., Osaka-shi, Osaka (JP); SUMITOMO ELECTRIC FINE POLYMER, INC., Sennan-gun, Osaka (JP)

(72) Inventors: Shingo NAKAJIMA, Osaka (JP); Jun SUGAWARA, Osaka (JP); Yoshitaka IKEDA, Osaka (JP); Masato TANAKA, Osaka (JP); Masatoshi ISHIKAWA, Osaka (JP)

(21) Appl. No.: 15/126,586

(22) PCT Filed: Nov. 3, 2015
(86) PCT No.: PCT/JP2015/080972

§ 371 Date: Sep. 16, 2016

(30) Foreign Application Priority Data
Jan. 20, 2015 (JP) 2015-008951

(51) Int. Cl. G03G 15/20

(52) U.S. Cl. CPC G03G 15/206

(57) ABSTRACT

An object is to provide a self-heat-generating fixing roller that has a simple structure and good durability and that can be easily produced. A self-heat-generating fixing roller according to an embodiment of the present invention includes a columnar core bar, a heat-insulating layer stacked on an outer circumferential side of the core bar, a heat-generating layer stacked on an outer circumferential side of the heat-insulating layer and heated by supplying electricity, and a mold-releasing layer stacked on an outer circumferential side of the heat-generating layer. The heat-insulating layer preferably contains a matrix containing a synthetic resin or rubber as a main component, and a plurality of pores contained in the matrix. The heat-generating layer preferably contains a matrix containing a synthetic resin or rubber as a main component, and a plurality of electrically conductive fillers contained in the matrix.

### TECHNICAL FIELD

The present invention relates to a self-heat-generating fixing roller.

### BACKGROUND ART

In image-forming apparatuses such as copy machines and laser beam printers, a heat fixing method is usually used in the final stage of printing and copying. This heat fixing method is a method for forming an image by allowing a transfer-receiving material, such as a printing sheet to which a toner image has been transferred, to pass between a heating roller having a heater therein and a pressure roller to thereby melt an unfixed toner by heating and to fix the toner to the transfer-receiving material.

An example of the existing heating roller is one described in Japanese Unexamined Patent Application Publication No. 2002-31972. In this heating roller, a heater is embedded in an axial direction of a roller, and a heat-resistant film is provided on the outer surface side of the roller and the heater. The heat-resistant film is heated by the heater, and the heated heat-resistant film rotates independently from the roller, thus heating a toner.

However, since the existing heating roller described above includes a heater therein, the heating roller is unsatisfactory in that the structure thereof is complex and the production process becomes complicated. In addition, there may be a disadvantage in that the heating roller has poor durability because the inner circumferential surface side of the heat-resistant film is rubbed with the roller and the heater.

### CITATION LIST

### Patent Literature

PTL 1: Japanese Unexamined Patent Application Publication No. 2002-31972

### SUMMARY OF INVENTION

### Technical Problem

The present invention has been made in view of the circumstances described above. An object of the present invention is to provide a self-heat-generating fixing roller that has a simple structure and good durability and that can be easily produced.

### Solution to Problem

A self-heat-generating fixing roller according to an embodiment of the present invention is a self-heat-generating fixing roller including a columnar core bar, a heat-insulating layer stacked on an outer circumferential side of the core bar, a heat-generating layer stacked on an outer circumferential side of the heat-insulating layer and heated by supplying electricity, and a mold-releasing layer stacked on an outer circumferential side of the heat-generating layer.

### Advantageous Effects of Invention

The self-heat-generating fixing roller has a simple structure and good durability and can be easily produced.

### BRIEF DESCRIPTION OF DRAWINGS

FIG. 1 is a schematic sectional view in a direction perpendicular to an axial direction, the sectional view illustrating a self-heat-generating fixing roller according to an embodiment of the present invention.

FIG. 2 is a schematic sectional view in the axial direction, the sectional view illustrating the self-heat-generating fixing roller in FIG. 1.

FIG. 3 is a schematic sectional view illustrating the relevant part of a fixing device including the self-heat-generating fixing roller in FIG. 1.

### DESCRIPTION OF EMBODIMENTS

### Description of Embodiments of the Present Invention

A self-heat-generating fixing roller according to an embodiment of the present invention is a self-heat-generating fixing roller including a columnar core bar, a heat-insulating layer stacked on an outer circumferential side of the core bar, a heat-generating layer stacked on an outer circumferential side of the heat-insulating layer and heated by supplying electricity, and a mold-releasing layer stacked on an outer circumferential side of the heat-generating layer.

As described above, the self-heat-generating fixing roller includes a heat-generating layer that is heated by supplying electricity. Accordingly, a heater need not be used, the fixing roller itself generates heat to thereby heat a toner through the mold-releasing layer, and thus the toner can be fixed to a transfer-receiving material. Since the self-heat-generating fixing roller does not require a heater, the self-heat-generating fixing roller has a simple structure and can be easily produced. Furthermore, according to the self-heat-generating fixing roller, since the stacked layers integrally rotate, the mold-releasing layer is unlikely to wear and good durability is obtained.

The heat-insulating layer preferably contains a matrix containing a synthetic resin or rubber as a main component, and a plurality of pores contained in the matrix. When the heat-insulating layer contains a matrix containing a synthetic resin or rubber as a main component, and a plurality of pores contained in the matrix, the heat-insulating layer has a better heat-insulating property, and it is possible to suppress a phenomenon in which heat of the heat-generating layer is transferred to the core bar side and lost.

The heat-generating layer preferably contains a matrix containing a synthetic resin or rubber as a main component, and a plurality of electrically conductive fillers contained in the matrix. When the heat-generating layer contains a matrix containing a synthetic resin or rubber as a main component, and a plurality of electrically conductive fillers contained in the matrix, the self-heat-generating fixing roller can have a suitable electrical resistance and suitable elasticity, and a nip is easily formed while having a heat-generating property.

The electrically conductive fillers are preferably a mixture of a metal powder and a carbon powder. When the electrically conductive fillers are a mixture of a metal powder and a carbon powder, the electrical resistance is easily adjusted.

The heat-generating layer may further contain an insulating filler in the matrix. Also when the heat-generating, layer further contains an insulating filler in the matrix, the electrical resistance is easily adjusted.

The electrically conductive fillers preferably have a needle-like shape. When the electrically conductive fillers have a needle-like shape, the electrical resistance is easily adjusted.

An electrical resistance between two ends of the heat-generating layer is preferably 5Ω or more and 100Ω or less. When an electrical resistance between two ends of the heat-generating layer is in the above range, a heating value suitable for fixing a toner image can be obtained by using a power supply unit having a typical structure.

The mold-releasing layer preferably contains a fluororesin as a main component. When the mold-releasing layer contains a fluororesin as a main component, the mold-releasing layer has a good mold releasability, good flexibility, and good heat resistance.

The self-heat-generating fixing roller preferably further includes a pair of cylindrical equipotential electrodes that are in contact with two end portions of the heat-generating layer. When the self-heat-generating fixing roller further includes a pair of cylindrical equipotential electrodes that are in contact with two end portions of the heat-generating layer, the whole of the heat-generating layer can generate heat evenly.

The self-heat-generating fixing roller preferably further includes an elastic layer between the heat-generating layer and the mold-releasing layer. When the self-heat-generating fixing roller further includes an elastic layer between the heat-generating layer and the mold-releasing layer, the amount of deformation of the mold-releasing layer is increased to facilitate the formation of a nip while reducing the amount of deformation of the heat-generating layer to prevent the heat-generating layer from tearing.

The term “columnar shape” also covers a so-called cylindrical shape having a cavity at the center. The term “main component” refers to the component having the largest content, and, for example, a component having a content of 50% by mass or more. The term “needle-like shape” refers to a shape having an aspect ratio (ratio of length to diameter of filler) of 1.5 or more, and preferably 2 or more. The cross-sectional shape of the filler is not limited to a circle. When the cross section of the filler is not a circle, the aspect ratio is determined by using the maximum length of the cross section as a diameter.

### Details of Embodiments of the Present Invention

A self-heat-generating fixing roller according to an embodiment of the present invention will now be described in detail with reference to the drawings.

### [Self-Heat-Generating Fixing Roller]

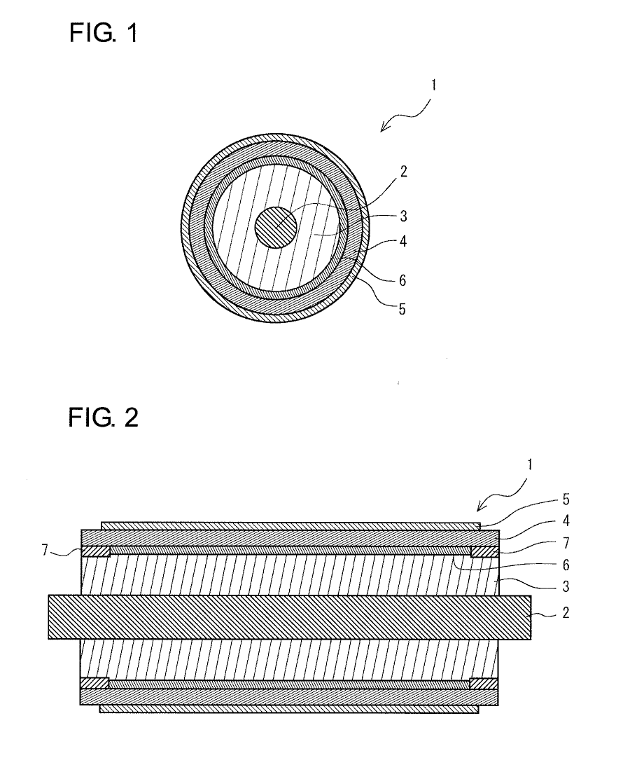

As illustrated in FIGS. 1 and 2, a self-heat-generating fixing roller 1 includes a columnar core bar 2, a heat-insulating layer 3 that is stacked directly on the outer circumference of the core bar 2, a heat-generating layer 4 that is stacked on the outer circumferential side of the heat-insulating layer and heated by supplying electricity, and a mold-releasing layer 5 that is stacked directly on the outer circumference of the heat-generating layer. The self-heat-generating fixing roller 1 further includes a primer layer 6 between the heat-insulating layer 3 and the heat-generating layer 4.

As illustrated in FIG. 2, in the self-heat-generating fixing roller 1, the length of the mold-releasing layer 5 in an axial direction is smaller than the length of the heat-generating layer 4 in the axial direction, and the outer circumferential surface of the heat-generating layer 4 is exposed on two end portions in the axial direction. The self-heat-generating fixing roller 1 further includes a pair of cylindrical equipotential electrodes 7 that are formed of a conductor and disposed so as to be in contact with the inner circumferential surface of two end portions of the heat-generating layer 4.

### <Core Bar>

The core bar 2 extends in the axial direction at the center of the self-heat-generating fixing roller 1. The core bar 2 may be hollow or solid.

As the core bar 2, a metal such as aluminum, an aluminum alloy, iron, or stainless steel, or a heat-resistant resin such as a polyimide or a polyamide may be used. Among heat-resistant resins, polyimides, which have good formability, good heat resistance, and good mechanical strength, are preferable.

The core bar 2 may have an average outer diameter of, for example, 5 mm or more and 40 mm or less. When the core bar 2 is hollow, the core bar 2 may have an average thickness of, for example, 10 μm or more and 40 mm or less. The core bar 2 may have a length in the axial direction of, for example, 100 mm or more and 500 mm or less.

### <Heat-Insulating Layer>

The heat-insulating layer 3 suppresses dissipation of heat generated by the heat-generating layer 4 to the core bar 2 side and improves the energy efficiency of the self-heat-generating fixing roller 1. The heat-insulating layer 3 preferably contains a matrix containing a synthetic resin or rubber as a main component, and a plurality of pores contained in the matrix. Furthermore, the heat-insulating layer 3 preferably has elasticity.

The rubber used as the main component of the matrix of the heat-insulating layer 3 is not particularly limited as long as the rubber has heat resistance. However, the rubber preferably has elasticity. A rubber having good heat resistance (heat-resistant rubber) is particularly preferable. A silicone rubber, a fluororubber, or a mixture thereof can be suitably used as the heat-resistant rubber.

Examples of the silicone rubber include dimethyl silicone rubber, fluorosilicone rubber, and methyl phenyl silicone rubber. Examples of the fluororubber include vinylidene fluoride rubber, tetrafluoroethylene-propylene rubber, and tetrafluoroethylene-perfluoromethylvinylether rubber.

Examples of the synthetic resin include phenolic resins (PF), epoxy resins (EP), melamine resins (MF), urea resins (UF), unsaturated polyester resins (UP), alkyd resins, polyurethanes (PUR), thermosetting polyimides (PI), polyethylene (PE), high-density polyethylene (HDPE), medium-density polyethylene (MDPE), low-density polyethylene (LDPE), polypropylene (PP), polyvinyl chloride (PVC), polyvinylidene chloride, polystyrene (PS), polyvinyl acetate (PVAc), acrylonitrile-butadiene-styrene resins (ABS), acrylonitrile-styrene resins (AS), polymethyl methacrylate (PMMA), polyamides (PA), polyacetal (POM), polycarbonate (PC), modified polyphenylene ethers (m-PPE), polybutylene terephthalate (PBT), polyethylene terephthalate (PET), and cyclic polyolefins (COP).

The pores in the matrix of the heat-insulating layer 3 can be formed by using a foaming agent, a hollow filler, or the like. For example, organic microballoons, hollow glass beads, or the like can be used as the hollow filler.

The foaming agent is a substance that is decomposed by heating and that generates, for example, nitrogen gas, carbon dioxide gas, carbon monoxide, ammonia gas, or the like. An organic foaming agent or an inorganic foaming agent can be used as the foaming agent.

Examples of the organic foaming agent include azo foaming agents such as azodicarbonamide (A. D. C. A) and azobisisobutyronitrile (A. I. B. N); nitroso foaming agents such as dinitrosopentamethylenetetramine (D. P. T) and N,N′-dinitroso-N,N′-dimethyl terephthalamide (D. N. D. M. T. A); hydrazides such as P-toluenesulfonyl hydrazide (T. S. H), P,P-oxybisbenzenesulfonyl hydrazide (O. B. S. H), and benzenesulfonyl hydrazide (B. S. H); trihydrazino triazine (T. H. T); and acetone-P-sulfonyl hydrazone. These may be used alone or in combination of two or more.

Examples of the inorganic foaming agent include sodium bicarbonate, ammonium carbonate, ammonium bicarbonate, sodium borohydride, sodium boron hydride, and silicon oxyhydride. In general, the gas generation speed of an inorganic foaming agent is lower than that of an organic foaming agent, and it is difficult to adjust the generation of the gas using an inorganic foaming agent. Therefore, the chemical foaming agents are preferably organic foaming agents.

The term “organic microballoon” refers to a type of hollow microsphere, and, for example, a hollow, spherical fine particle formed of an organic polymeric material such as a thermosetting resin, e.g., a phenolic resin; a thermoplastic resin, e.g., polyvinylidene chloride; or a rubber. Incorporation of organic microballoons in the heat-insulating layer 3 improves flexibility, heat resistance, and dimensional stability of the heat-insulating layer 3. Since the organic microballoons are spherical, even when the organic microballoons are incorporated in a composition that forms the heat-insulating layer 3, stress anisotropy is not easily caused. Accordingly, the organic microballoons are unlikely to decrease uniformity of a heat-insulating property and a hardness of the heat-insulating layer 3. By using, as the organic microballoons, heat-resistant organic microballoons containing a thermosetting resin such as a phenolic resin, heat resistance of the heat-insulating layer 3 is further improved. Commercially available organic microballoons may be used as the organic microballoons.

The average diameter of the organic microballoons is usually several micrometers or more and several hundreds of micrometers or less, and preferably 5 μm or more and 200 μm or less.

The upper limit of the porosity of the heat-insulating layer 3 is preferably 60%, more preferably 50%, and still more preferably 45%. The lower limit of the porosity of the heat-insulating layer 3 is preferably 5%, more preferably 10%, and still more preferably 15%. When the porosity of the heat-insulating layer 3 exceeds the upper limit, strength of the heat-insulating layer 3 may be insufficient. When the porosity of the heat-insulating layer 3 is less than the lower limit, the heat-insulating property of the heat-insulating layer 3 may be insufficient. Note that the porosity is a value measured as an area ratio when a cross section is observed with a microscope.

The upper limit of the average thickness of the heat-insulating layer 3 is preferably 50 mm, and more preferably 20 mm. The lower limit of the average thickness is 20 μm, and more preferably 100 μm. When the average thickness exceeds the upper limit, the size of the self-heat-generating fixing roller 1 may be unnecessarily increased. When the average thickness is less than the lower limit, the heat-insulating property of the heat-insulating layer 3 may be insufficient, and the energy efficiency of the self-heat-generating fixing roller 1 may decrease.

The heat-insulating layer 3 and the heat-generating layer 4 are preferably joined to each other either directly or with another layer therebetween. By joining the heat-insulating layer 3 to the heat-generating layer 4, it is possible to prevent abrasion due to the friction of the inner circumferential surface (surface on the core bar 2 side) of the heat-generating layer 4 with the heat-insulating layer 3 or another layer, and durability of the self-heat-generating fixing roller 1 is improved. In this embodiment, the heat-insulating layer 3 and the heat-generating layer 4 are joined to each other by stacking a primer layer 6 described below between the heat-insulating layer 3 and the heat-generating layer 4.

### <Heat-Generating Layer>

The heat-generating layer 4 is a layer that generates heat due to the ohmic loss (Joule loss) when electricity is supplied from two end portions exposed from the mold-releasing layer 5.

The heat-generating layer 4 is not particularly limited as long as a current can be allowed to flow in the heat-generating layer 4 and the heat-generating layer 4 generates heat due to the ohmic loss. The heat-generating layer 4 preferably contains a matrix containing a synthetic resin or rubber as a main component, and a plurality of electrically conductive fillers contained in the matrix.

The main component of the matrix of the heat-generating layer 4 may be a synthetic resin or rubber having heat resistance. Among these, heat-resistant resins are preferable. Examples of the heat-resistant resins include polyimides and polyamides. Polyimides, which have good heat resistance and good mechanical strength, are particularly preferable. Examples of the heat-resistant rubber that can be used include silicone rubbers, fluororubbers, and mixtures thereof.

The matrix of the heat-generating layer 4 may contain an insulating filler. By incorporating an insulating filler, electrical contact between electrically conductive fillers is limited, and the electrical resistance of the heat-generating layer 4 can be adjusted relatively easily.

The material of the insulating filler is not particularly limited as long as the material has an insulating property. An inorganic filler having a high thermal conductivity, such as titanium oxide, metal silicon, magnesium oxide, magnesium carbonate, magnesium hydroxide, silicon oxide, alumina, boron nitride, or aluminum nitride is preferably used.

Known electrically conductive fillers can be used as the electrically conductive fillers. Examples thereof include powders of a metal such as gold or nickel; resin particles plated with a metal; and carbon powders such as carbon black and carbon nanotubes. Among these, from the viewpoint of heat resistance and electrical conductivity, the electrical conductive fillers preferably include a carbon powder, and more preferably a mixture of a metal powder and a carbon powder. The metal powder is preferably a nickel powder.

When the electrically conductive fillers are a mixture of a metal powder and a carbon powder, the upper limit of the ratio of the carbon powder in the electrically conductive fillers of the heat-generating layer 4 is preferably 97% by volume, and more preferably 95% by volume.

The lower limit of the ratio of the carbon powder in the electrically conductive fillers of the heat-generating layer 4 is preferably 30% by volume, and more preferably 50% by volume. When the ratio of the carbon powder in the electrically conductive fillers of the heat-generating layer 4 exceeds the upper limit, the metal powder may not be evenly dispersed, and it may not be easy to make the electrical resistance of the heat-generating layer 4 uniform. When the ratio of the carbon powder in the electrically conductive fillers of the heat-generating layer 4 is less than the lower limit, a decrease in the electrical resistance of the heat-generating layer 4 due to the electrically conductive fillers is large, and it may not be easy to adjust the electrical resistance of the heat-generating layer 4.

The electrically conductive fillers in the heat-generating layer 4 preferably have a needle-like shape. When the electrically conductive fillers have a needle-like shape, an orientation is provided to the electrically conductive fillers. Consequently, the electrical resistivity of the heat-generating layer 4 can be made low in a direction in which the electrically conductive fillers are oriented and made high in a direction perpendicular to the direction in which the electrically conductive fillers are oriented. With this structure, the electrical resistivity of the heat-generating layer 4 in the axial direction can be made lower than the electrical resistivity of the heat-generating layer 4 in the circumferential direction. In this case, a current flows stably in the axial direction, and thus heat characteristics are stabilized.

The lower limit of the aspect ratio of the electrically conductive fillers is preferably 1.5, and more preferably 2.0. The upper limit of the aspect ratio of the electrically conductive fillers is preferably 1,000, and more preferably 100. When the aspect ratio of the electrically conductive fillers is less than the lower limit, the difference in electrical resistivity between the axial direction and the circumferential direction may not be provided. When the aspect ratio of the electrically conductive fillers exceeds the upper limit, coating of the heat-generating layer 4 may not be easily performed.

Examples of a needle-like carbon powder include carbon nanotubes (hereinafter, may be referred to as “CNTs”). CNTs are nano-sized cylindrical carbons. CNTs typically have a specific gravity of about 2.0, and an aspect ratio (ratio of length to diameter) of 50 or more and 1,000 or less. CNTs are typically classified into single-wall carbon nanotubes and multi-wall carbon nanotubes. The multi-wall CNTs have a structure in which a plurality of carbon tubes are concentrically arranged. Known methods for producing a CNT can be used. However, a vapor-phase growth method, with which the diameter of a CNT is easily controlled and which has good mass productivity, is preferable.

The upper limit of the average diameter of CNTs is preferably 500 nm, and more preferably 300 nm. The lower limit of the average diameter is preferably 100 nm. When the average diameter exceeds the upper limit, flexibility of the heat-generating layer 4 and smoothness of the surface thereof may decrease. When the average diameter is less than the lower limit, dispersibility of the CNTs may decrease and mechanical strength of the heat-generating layer 4 may decrease, or productivity of the CNTs may decrease. Note that the average diameter of CNTs is, for example, the average of the minor axis diameter of CNTs measured by a laser scattering method or scanning electron microscopy.

The upper limit of the average length of CNTs is preferably 50 μm, more preferably 30 μm, and still more preferably 20 μm. The lower limit of the average length is preferably 1 μm. When the average length exceeds the upper limit, dispersibility of the CNTs may decrease and mechanical strength of the heat-generating layer 4 may decrease, or smoothness of the surface of the heat-generating layer 4 may decrease. When the average length is less than the lower limit, mechanical strength such as breaking elongation of the heat-generating layer 4 may be insufficient. Note that the average length of CNTs is, for example, the average of the length of CNTs measured by a laser scattering method or scanning electron microscopy.

As a carbon powder having a shape other than a needle-like shape, for example, shell-like carbon particles may be used. By using such shell-like carbon particles, a change in the electrical resistance of the heat-generating layer 4 with respect to the amount of carbon powder added becomes gentle, and the electrical resistance of the heat-generating layer 4 is easily adjusted.

An example of a needle-like metal powder is, but is not particularly limited to, a needle-like nickel powder.

The upper limit of the content of the electrically conductive fillers in the heat-generating layer 4 is preferably 60% by volume, more preferably 55% by volume, and still more preferably 50% by volume. The lower limit of the content is preferably 5% by volume, more preferably 10% by volume, and still more preferably 15% by volume. When the content exceeds the upper limit, heat resistance, mechanical strength, etc. of the heat-generating layer 4 may decrease. When the content is less than the lower limit, it may be difficult to control the resistance of the heat-generating layer 4 in a desired range.

The upper limit of the average thickness of the heat-generating layer 4 is preferably 300 μm, more preferably 250 μm, and still more preferably 200 μm. The lower limit of the average thickness is preferably 5 μm, more preferably 10 μm, and still more preferably 30 μm. When the average thickness exceeds the upper limit, the production cost of the self-heat-generating fixing roller 1 may increase. When the average thickness is less than the lower limit, the heat-generating layer 4 may be easily damaged by heat or shock.

The upper limit of the electrical resistance between the two ends of the heat-generating layer 4 is preferably 100Ω, more preferably 80Ω, and still more preferably 60Ω. The lower limit of the electrical resistance between the two ends of the heat-generating layer 4 is preferably 5Ω, more preferably 7.5Ω, and still more preferably 10Ω. When the resistance exceeds the upper limit, the voltage necessary for increasing the temperature of the heat-generating layer 4 increases, and a power supply unit for driving the self-heat-generating fixing roller 1 may be unnecessarily expensive. When the resistance is less than the lower limit, the current necessary for increasing the temperature of the heat-generating layer 4 increases, and a power supply unit for driving the self-heat-generating fixing roller 1 may also be unnecessarily expensive.

The upper limit of the electrical resistance (length resistivity) per unit length of the heat-generating layer 4 in the axial direction is preferably 1,000 Ω/m, more preferably 800 Ω/m, and still more preferably 600 Ω/m. The lower limit of the length resistivity is preferably 0.01 Ω/m, more preferably 0.1 Ω/m, and still more preferably 1 Ω/m. When the length resistivity exceeds the upper limit, the electrical resistance of the heat-generating layer 4 may be excessively high. When the length resistivity is less than the lower limit, the electrical resistance of the heat-generating layer 4 may be excessively low.

As a method for applying a current to the heat-generating layer 4, a method is used in which an electrode plate, a brush, or the like (not shown) is brought into contact with the outer circumferential surface of each of the exposed portions on the two ends of the heat-generating layer 4. An electrode formed of a tubular conductor may be provided on the outer circumferential surface of the heat-generating layer 4, and an electrode plate, a brush, or the like may be brought into contact with this terminal.

### <Mold-Releasing Layer>

The mold-releasing layer 5 is a layer that is stacked directly on the outer circumferential surface of the heat-insulating layer 3 and that comes in contact with a toner. This mold-releasing layer 5 prevents a toner from adhering to the self-heat-generating fixing roller 1.

As a main component of the mold-releasing layer 5, for example, thermoplastic resins and thermosetting resins can be used. Examples of the thermoplastic resins include vinyl resins, polyesters, polyolefins, acrylic resins, fluororesins, epoxy resins, phenolic resins, and urea resins. Among these, fluororesins, which have good mold releasability, good flexibility, and good heat resistance, are preferable. These resins may be used alone or as a mixture of two or more resins.

Examples of the fluororesins include polytetrafluoroethylene (PTFE), tetrafluoroethylene-perfluoroalkylvinylether copolymers (PFA), and tetrafluoroethylene-hexafluoropropylene copolymers (FEP). Among these, PFA or PTFE having a low molecular weight and good mold releasability is preferable.

The mold-releasing layer 5 may contain an additive such as a thermally conductive filler. By incorporating a thermally conductive filler in the mold-releasing layer 5, heat of the heat-generating layer 4 can be efficiently transferred to a toner.

Examples of the thermally conductive filler include metals, ceramics, boron nitride, carbon nanotubes, alumina, and silicon carbide.

The mold-releasing layer 5 preferably has an insulating property. Specifically, the lower limit of the electrical resistance per unit length of the mold-releasing layer 5 in the axial direction is preferably 10¹⁴ Ω/m. When the length resistivity of the mold-releasing layer 5 is less than the lower limit, electrical leakage occurs from the heat-generating layer 4 through the mold-releasing layer 5. Consequently, heat generation by the heat-generating layer 4 may become insufficient, an electrical shock may occur, or the apparatus may malfunction.

The upper limit of the average thickness of the mold-releasing layer 5 is preferably 50 μm, and more preferably 35 μm.

The lower limit of the average thickness is preferably 1 μm, and more preferably 5 μm. When the average thickness exceeds the upper limit, the size of the self-heat-generating fixing roller 1 may be unnecessarily increased, or the heat efficiency of the self-heat-generating fixing roller 1 may decrease. When the average thickness is less than the lower limit, strength of the mold-releasing layer 5 may be insufficient.

The mold-releasing layer 5 may be joined to the heat-generating layer 4. Alternatively, the mold-releasing layer 5 may not be joined to the heat-generating layer 4 and may be independently rotatable. However, the mold-releasing layer 5 is preferably joined to the heat-generating layer 4. By joining the mold-releasing layer 5 to the heat-generating layer 4, it is possible to prevent abrasion due to the friction of the inner circumferential surface (surface on the side that contacts the heat-generating layer 4) of the mold-releasing layer 5 with the heat-generating layer 4, and durability of the self-heat-generating fixing roller 1 is improved. Examples of the method for joining the mold-releasing layer 5 to the heat-generating layer 4 include, but are not particularly limited to, a method in which the joining is performed at the same time of the formation of the mold-releasing layer 5 or the heat-generating layer 4, and a method in which the joining is performed after the formation of the mold-releasing layer 5 and the heat-generating layer 4. In addition to these methods, by selecting the main components of the mold-releasing layer 5 and the heat-generating layer 4 so that the main components are a combination having high affinity, the mold-releasing layer 5 and the heat-generating layer 4 can be joined to each other more strongly.

Examples of the method in which the joining is performed at the same time of the formation of the mold-releasing layer 5 or the heat-generating layer 4 include a method including forming the heat-generating layer 4 by, for example, applying or extruding the heat-generating layer 4 on the inner circumferential surface of the mold-releasing layer 5, a method including forming the mold-releasing layer 5 by, for example, applying or extruding the mold-releasing layer 5 on the outer circumferential surface of the heat-generating layer 4, and a method including coextruding the mold-releasing layer 5 and the heat-generating layer 4.

Examples of the method in which the joining is performed after the formation of the mold-releasing layer 5 and the heat-generating layer 4 include a method including bonding the mold-releasing layer 5 to the heat-generating layer 4 with an adhesive, a method including performing a surface treatment, such as a plasma treatment, on a surface of the mold-releasing layer 5, the surface being disposed on the side on which the heat-generating layer 4 is to be formed, and a method in which when the main component of the mold-releasing layer 5 is a fluororesin, the mold-releasing layer 5 and the heat-generating layer 4 are chemically bonded to each other by, for example, heating, irradiation with ionizing radiation, or application of a coupling agent.

### <Primer Layer>

The primer layer 6 is a layer stacked between the heat-insulating layer 3 and the heat-generating layer 4 and improves adhesiveness between the heat-insulating layer 3 and the heat-generating layer 4. The main component of the primer layer 6 can be appropriately selected in accordance with the main components of the heat-insulating layer 3 and the heat-generating layer 4. Specifically, for example, a silicone rubber, a fluororesin, or the like can be used as the main component of the primer layer 6.

Commercially available general-purpose compositions can be used as a composition for forming the primer layer 6. Examples of such compositions include “X-33-174” manufactured by Shin-Etsu Chemical Co., Ltd., “KE-1880” manufactured by Shin-Etsu Chemical Co., Ltd., “DY39-051” manufactured by Dow Corning Toray Co., Ltd., “PJ992CL” manufactured by Du-Pont Mitsui Co., Ltd., and “GLP103SR” manufactured by Daikin Industries, Ltd.

The upper limit of the average thickness of the primer layer 6 is preferably 30 μm, and more preferably 20 μm. The lower limit of the average thickness is preferably 1 μm, and more preferably 5 μm. When the average thickness exceeds the upper limit, the production cost of the self-heat-generating fixing roller 1 may be increased. When the average thickness is less than the lower limit, adhesiveness between the heat-insulating layer 3 and the heat-generating layer 4 may be unlikely to improve.

### <Equipotential Electrodes>

The equipotential electrodes 7 make a voltage applied to the outer circumferential surface of two end portions of the heat-generating layer 4 uniform in the circumferential direction of the heat-generating layer 4. With this structure, a current is allowed to flow substantially uniform in the whole of the heat-generating layer 4, so that the heat-generating layer 4 generates heat evenly.

The equipotential electrodes 7 are formed of a conductor having a sufficiently low electrical resistance, and may be formed by using a metal foil, an electrically conductive paste, or the like. A copper foil is suitably used as the metal foil. A metal tape obtained by applying an adhesive onto a metal foil may be used.

### [Method for Producing Self-Heat-Generating Fixing Roller]

The self-heat-generating fixing roller 1 can be easily and reliably produced by a production method including a step of forming a material for forming a heat-generating layer 4 into a film; a step of stacking a material for forming a mold-releasing layer 5 on a surface of the film-like heat-generating layer 4 to form a laminate; a laminate-charging step of charging the laminate of the heat-generating layer 4 and the mold-releasing layer 5 so as to conform to the inner circumferential surface of a columnar cavity of a mold; an equipotential electrode-arranging step of arranging equipotential electrodes 7 on the inner circumferential surface of two end portions of the heat-generating layer 4; a primer layer-forming step of forming a primer layer 6 on the inner circumferential surface of the heat-generating layer 4; and a heat-insulating layer-forming step of injection-molding a composition for forming a heat-insulating layer in a state in which a core bar 2 is charged so that the central axis of the core bar 2 coincides with the central axis of the cavity.

Since the self-heat-generating fixing roller 1 does not include a heater, a step of producing a heater and a step of embedding a heater in a roller are not necessary.

### <Film-Forming Step>

In the film-forming step, a resin composition prepared by diluting a material for forming a heat-generating layer 4 with a solvent is applied onto a base (mold-releasing film) and baked to form the film-like heat-generating layer 4.

A known existing coating method such as a spin coating method, a spray coating method, a bar coating method, a die coating method, a slit coating method, a roll coating method, or a dip coating method can be used as a method for applying the resin composition.

In the baking of the resin composition, the solvent in the resin composition is volatilized. The baking temperature is, for example, 100° C. or more and 500° C. or less.

### <Stacking Step>

In the stacking step, a mold-releasing layer 5 is stacked on a surface of the film-like heat-generating layer 4. As the method for stacking the mold-releasing layer 5, for example, a method including applying a resin composition for forming a mold-releasing layer 5 to a surface of the heat-generating layer 4 and baking the resin composition, or a method including bonding a mold-releasing layer 5 that has been formed into a film in advance to the heat-generating layer 4 with an adhesive or the like can be employed. In order to improve adhesiveness between the heat-generating layer 4 and the mold-releasing layer 5, a plasma treatment, a primer treatment, or the like may be performed on a surface of the film-like mold-releasing layer 5, the surface being to be bonded to the heat-generating layer 4.

### <Laminate-Charging Step>

In the laminate-charging step, a mold having a columnar cavity is used, and the resulting laminate of the heat-generating layer 4 and the mold-releasing layer 5 is charged in the mold such that the laminate forms a tube that conforms to the inner circumferential surface of the mold.

Examples of the main component of the mold include iron, stainless steel, aluminum, and alloys thereof.

A smoothing treatment is preferably performed on the inner circumferential surface of the mold. By performing a smoothing treatment on the inner circumferential surface of the mold, smoothness of the surface of the self-heat-generating fixing roller 1 improves. Therefore, a nip property improves, and mold removability when the self-heat-generating fixing roller 1 is pulled out from the mold after the formation of the heat-insulating layer 3 improves. Examples of the smoothing treatment include the following. When the main component of the mold is aluminum, the mold may be formed by drawing. When the main component of the mold is a metal other than aluminum, chromium plating, nickel plating, or the like may be performed. A surface roughness (Rz) of the inner circumferential surface of the mold is preferably 20 μm or less, and more preferably 5 μm or less.

The inner diameter of the cavity can be appropriately adjusted in accordance with the diameter of the self-heat-generating fixing roller 1. The upper limit of the value of (D1−D2)/D1 where D1 represents the inner diameter of the cavity and D2 represents the outer diameter of the tubular mold-releasing layer 5 is preferably 10%, and more preferably 8%. The lower limit of the value of (D1−D2)/D1 is preferably 3%, and more preferably 4%. When the value of (D1−D2)/D1 exceeds the upper limit, wrinkles are generated on the outer circumferential surface of the tubular mold-releasing layer 5, and uniformity of a nip pressure of the self-heat-generating fixing roller 1 may decrease. When the value of (D1−D2)/D1 is less than the lower limit, it becomes difficult to charge the tubular mold-releasing layer 5 along the inner circumferential surface of the mold, and the production efficiency of the self-heat-generating fixing roller 1 may decrease.

The tubular mold-releasing layer 5 is preferably longer than the mold. When the tubular mold-releasing layer 5 is longer than the mold, in charging the tubular mold-releasing layer 5 in the mold, two end portions of the tubular mold-releasing layer 5 can be made to protrude from the mold, and the protruding portions can be turned back toward the outside of two end portions of the mold. With this structure, even when the outer diameter of the tubular mold-releasing layer 5 is smaller than the inner diameter of the mold, the airtightness of a gap between the mold and the tubular mold-releasing layer 5 can be maintained easily and reliably.

When the two end portions of the tubular mold-releasing layer 5 are turned back, the average length of the turned-back portion (the distance from the position at which the mold-releasing layer 5 is bent to the nearest end of the mold-releasing layer 5) is preferably 10 mm or more and 30 mm or less. When the average length of the turned-back portion is less than the lower limit, the effect due to the turning back may not be sufficiently obtained. When the average length of the turned-back portion exceeds the upper limit, an excess length of the tubular mold-releasing layer 5 may be generated.

In this step, first, a mold having a columnar cavity is prepared. The inner circumferential surface of the mold is cleaned by blowing air or the like to remove adhering contaminants. Subsequently, a tubular mold-releasing layer 5 is inserted into the mold, and opening diameters of two end portions of the mold-releasing layer 5 are expanded. The expanded portions are turned back toward the outside of the mold to form turned-back portions.

Subsequently, a vacuum line is connected to a gap formed between the tubular mold-releasing layer 5 and the inner circumferential surface of the mold, and vacuum suction is performed so that the tubular mold-releasing layer 5 is suctioned on the inner circumferential surface of the mold. Subsequently, fixing components are attached to the two end sides of the mold so that the turned-back portions are brought into close contact with the outer circumferential surface of the mold.

### <Equipotential Electrode-Arranging Step>

In the equipotential electrode-arranging step, equipotential electrodes are formed on the inner circumferential surface of two end portions of the heat-generating layer 4 by, for example, applying an electrically conductive paste and baking the electrically conductive paste.

### <Primer Layer-Forming Step>

In the primer layer-forming step, a composition for forming a primer layer is applied onto the inner circumferential surface of the heat-generating layer 4 and dried to form a primer layer 6. Examples of the composition for forming a primer layer include compositions containing a resin exemplified in the primer layer 6 described above, an inorganic filler, etc. The composition for forming a primer layer can be dried by heating the mold and the laminate of the mold-releasing layer 5, the heat-generating layer 4, and the composition for forming a primer layer under vacuum while rotating about the central axis of the mold.

### <Heat-Insulating Layer-Forming Step>

In the heat-insulating layer-forming step, a core bar 2 is inserted in the hollow portion of the laminate of the mold-releasing layer 5, the heat-generating layer 4, and the primer layer 6 such that the central axis of the mold and the central axis of the core bar 2 substantially coincide with each other. Subsequently, a composition for forming a heat-insulating layer is injected between the primer layer 6 and the core bar 2 and vulcanized to form a heat-insulating layer 3.

The core bar 2 can be produced by a known method. When a heat-resistant resin is used as a material for forming the core bar 2, a hollow columnar core bar 2 can be formed easily and reliably by, for example, applying the resin onto an outer circumferential surface of a drum-shaped mold, heating the resin while rotating the mold, and removing the mold.

Examples of the composition for forming a heat-insulating layer include compositions containing a resin exemplified in the heat-insulating layer 3 described above, etc.

After the injection of the composition for forming a heat-insulating layer, mold covers are placed on two ends of the mold, and the composition for forming a heat-insulating layer is heated at a predetermined temperature for a predetermined time to form a heat-insulating layer 3. Subsequently, the vacuum between the mold and the tubular mold-releasing layer 5 is opened to remove, from the mold, the core bar 2 and the laminate of the heat-insulating layer 3, the primer layer 6, the heat-generating layer 4, and mold-releasing layer 5. Thus, the self-heat-generating fixing roller 1 is obtained.

After the mold is removed, vulcanization is preferably further performed. By further performing vulcanization after the removal of the mold, it is possible to reduce the remaining of a volatile component in the heat-insulating layer 3 and solidification failure of the heat-insulating layer 3 due to insufficient vulcanization of the heat-insulating layer 3.

### <Advantages>

The self-heat-generating fixing roller 1 includes the heat-generating layer 4 that is heated by supplying electricity, as described above. Thus, a heater need not be used, the fixing roller itself generates heat to thereby heat a toner through the mold-releasing layer 5, and thus the toner can be fixed to a transfer-receiving material. Since the self-heat-generating fixing roller 1 does not require a heater, the self-heat-generating fixing roller 1 has a simple structure and can be easily produced. Furthermore, according to the self-heat-generating fixing roller 1, since the stacked layers integrally rotate, the mold-releasing layer 5 is unlikely to wear and good durability is obtained.

Since the self-heat-generating fixing roller 1 includes the heat-insulating layer 3 that contains a matrix containing a synthetic resin or rubber as a main component, and a plurality of pores contained in the matrix, the heat-insulating layer 3 has a better heat-insulating property, and it is possible to suppress a phenomenon in which heat of the heat-generating layer 4 is transferred to the core bar 2 side and lost.

Since the self-heat-generating fixing roller 1 includes the heat-generating layer 4 that contains a matrix containing a synthetic resin or rubber as a main component, and a plurality of electrically conductive fillers contained in the matrix, the self-heat-generating fixing roller 1 can have a suitable electrical resistance and suitable elasticity, and a nip is easily formed while having a heat-generating property.

In the self-heat-generating fixing roller 1, since a material of the electrically conductive fillers in the heat-generating layer 4 is a metal or carbon, the electrical resistance of the heat-generating layer 4 can be stably a preferred value. Since the electrically conductive fillers have a needle-like shape, the electrical resistance can be more easily adjusted. Since the electrically conductive fillers are a mixture of a metal powder and a carbon powder, the electrical resistance can be more easily adjusted.

Since the self-heat-generating fixing roller 1 further includes a pair of cylindrical equipotential electrodes 7 that are in contact with the inner circumferential surface of two end portions of the heat-generating layer 4, a current is evenly allowed to flow in the whole of the heat-generating layer 4, and heat is generated evenly.

### [Fixing Device]

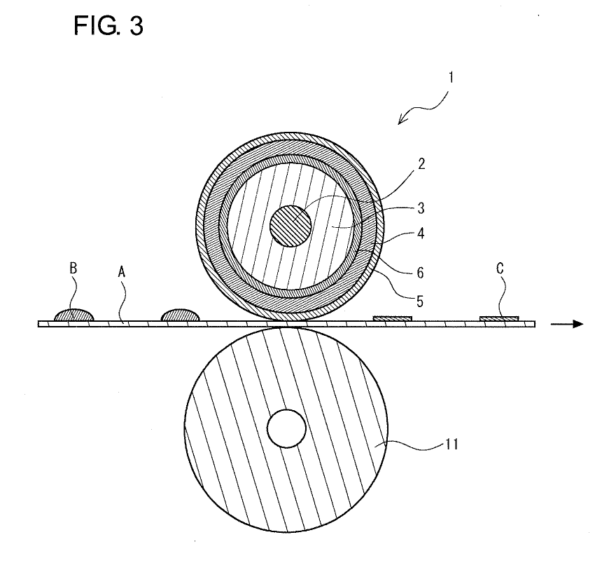

A fixing device illustrated in FIG. 3 is a fixing device used in an electrophotographic image-forming apparatus and includes the self-heat-generating fixing roller 1 functioning as a fixing roller and a pressure roller 11 that is arranged to form a pair with the self-heat-generating fixing roller 1. In this fixing device, a transfer-receiving material A in which an unfixed toner B is stacked on a surface thereof is heated and pressed by the self-heat-generating fixing roller 1 and the pressure roller 11 to fix the unfixed toner B and form a fixed toner C.

The fixing device including the self-heat-generating fixing roller 1 as a fixing roller can be produced at a low cost because the self-heat-generating fixing roller 1 has a simple structure and good durability and can be easily produced.

### Other Embodiments

It is to be understood that the embodiments disclosed herein are only illustrative and are not restrictive in all respects. The scope of the present invention is not limited to the structures of the embodiments but is defined by the claims described below. It is intended that the scope of the present invention include equivalents of the claims and all modifications within the scope of the claims.

The self-heat-generating fixing roller may further include an elastic layer between the heat-generating layer and the mold-releasing layer.

When an elastic layer is further provided between the heat-generating layer and the mold-releasing layer, the amount of deformation of the mold-releasing layer is increased to facilitate the formation of a nip while reducing the amount of deformation of the heat-generating layer to prevent the heat-generating layer from tearing. When an elastic layer is provided between the heat-generating layer and the mold-releasing layer, the heat-insulating layer may be a layer that does not have elasticity.

The elastic layer formed between the heat-generating layer and the mold-releasing layer is preferably a layer that contains a matrix containing a rubber as a main component, and a plurality of pores contained in the matrix. The rubber is particularly preferably a rubber having good heat resistance. As the heat-resistant rubber, a silicone rubber, a fluororubber, or a mixture thereof can be suitably used.

The thickness of the elastic layer formed between the heat-generating layer and the mold-releasing layer is determined in consideration of elasticity etc. so that a suitable nip can be formed.

In the above embodiment, a description has been made using, as an example, a self-heat-generating fixing roller including a primer layer between the heat-insulating layer and the heat-generating layer. However, the structure of the self-heat-generating fixing roller is not limited to this. Alternatively, the heat-generating layer may be stacked directly on the outer circumferential surface of the heat-insulating layer without providing a primer layer. In this case, examples of the method for joining the heat-insulating layer and the heat-generating layer include methods similar to the methods for joining the mold-releasing layer and the heat-generating layer, the methods being described above as examples.

A primer layer may be provided between the heat-insulating layer and each of the equipotential electrodes.

A primer layer may be stacked between the heat-generating layer and the mold-releasing layer. By stacking a primer layer between the heat-generating layer and the mold-releasing layer, joint strength between the heat-generating layer and the mold-releasing layer can be improved.

In the self-heat-generating fixing roller, the equipotential electrodes are not essential.

Besides a method using a laminate of a heat-generating layer and a mold-releasing layer, the method for producing the self-heat-generating fixing roller may be a method including arranging a core bar in the inner circumference of a heat-generating layer, filling the gap between the heat-generating layer and the core bar with a heat-insulating layer, and then stacking a mold-releasing layer on the outer circumferential surface of the heat-generating layer.

The laminate of the heat-generating layer and the mold-releasing layer may be formed by forming a film-like mold-releasing layer, and applying, onto the film-like mold-releasing layer, a resin composition for forming a heat-generating layer.

### Examples

The present invention will now be described in detail using Examples. However, the present invention is not restrictively interpreted on the basis of the description of the Examples.

### [Trial Products]

A resin composition containing a resin serving as a matrix, a solvent that dissolves the matrix, and electrically conductive fillers was applied and baked to produce a trial product of a heat-generating layer having a length in an axial direction of 232 mm, a diameter of an outer circumferential surface of 56 mm, and an average thickness of 57 μm. As shown in Table I, for Compositions 1 to 14 containing different matrixes and different electrically conductive fillers, trial products of a heat-generating layer obtained by applying a resin composition in a direction perpendicular to the axial direction (circumferential direction) and trial products of a heat-generating layer obtained by applying a resin composition in a direction parallel to the axial direction were produced.

### (Matrix)

Two types of varnishes were used as varnishes in which a matrix for forming the heat-generating layers of Compositions 1 to 14 is dissolved in a solvent. Specifically, a polyimide varnish “U-Varnish-S” manufactured by UBE Industries, Ltd. was used as Varnish 1. A polyimide varnish “Pyre ML” manufactured by I.S.T Corporation was used as Varnish 2. The amounts of varnishes mixed in each of Compositions 1 to 14 are shown in Table I.

### (Electrically Conductive Filler)

At least one type of filler selected from a carbon nanotube and needle-like nickel was used as the electrically conductive fillers in the resin compositions having Compositions 1 to 14. A carbon fiber “VGCF-H” (average diameter: 200 nm, average length: 6 μm) manufactured by Showa Denko K.K. was used as the carbon nanotube. A nickel powder “Type 255” (average length: 2.2 to 2.8 μm) manufactured by a carbonyl process and by Vale was used as the needle-like nickel. The amounts of electrically conductive fillers mixed in Compositions 1 to 14 are shown in Table I. Note that the symbol “−” in the table means that the filler is not mixed.

### (Electrical Resistance)

For each of the trial products of a heat-generating layer produced by using the resin compositions having Compositions 1 to 14, an electrical resistance between two ends was measured. The measuring results are also shown in Table I. Note that the symbol “>10⁶” represents that the electrical resistance exceeded 10 MΩ, which was the upper limit of the measurement range of a tester used in this measurement.

TABLE I

| | Amount of | | Amount of electrically | | | Resistance of heat- | |
|---|---|---|---|---|---|---|---|
| | matrix mixed | | conductive filler mixed | | | generating layer | |
| | (wt %) | | (vol %) | | | (Ω) | |
| | Varnish | Varnish | | Needle-like | | Perpendicular | Parallel |
| | 1 | 2 | CNT | Ni | Total | coating | coating |
| Composition 1 | 80 | 20 | 30 | — | 30 | 44 | 26 |
| Composition 2 | 80 | 20 | — | 5 | 5 | >10⁶ | >10⁶ |
| Composition 3 | 80 | 20 | — | 10 | 10 | >10⁶ | >10⁶ |
| Composition 4 | 80 | 20 | — | 15 | 15 | 36 | 26 |
| Composition 5 | 80 | 20 | — | 20 | 20 | 3.5 | 2.5 |
| Composition 6 | 80 | 20 | — | 30 | 30 | 0.5 | 0.5 |
| Composition 7 | 80 | 20 | — | 40 | 40 | 0.3 | 0.3 |
| Composition 8 | 80 | 20 | 10 | 15 | 25 | 20 | 15 |
| Composition 9 | 80 | 20 | 20 | 15 | 35 | 16 | 12 |
| Composition 10 | 80 | 20 | 20 | — | 20 | 279 | 149 |
| Composition 11 | 80 | 20 | 30 | — | 30 | 44 | 26 |
| Composition 12 | 80 | 20 | 40 | — | 40 | 28 | 18 |
| Composition 13 | 50 | 50 | 40 | — | 40 | 34 | 18 |
| Composition 14 | 20 | 80 | 40 | — | 40 | 40 | 14 |

The electrical resistances of the heat-generating layers obtained by using the resin compositions having Compositions 1 to 14 will be discussed. Regarding Compositions 1 and 4 and Compositions 8 to 14, heating values that can be used as a fixing roller for a fixing device can be obtained regardless of the coating direction. However, regarding the heat-generating layers obtained by using the resin compositions having Compositions 2 and 3, the electrical resistances are excessively high. Regarding the heat-generating layers obtained by using the resin compositions having Compositions 5 to 7, the electrical resistances are excessively low. Accordingly, it is believed that it is difficult to obtain a suitable heating value by using a power supply unit that is used for a typical heating roller.

It was confirmed that, regardless of the compositions of the resin compositions, the electrical resistance between two ends of a heat-generating layer formed by applying a resin composition in a direction perpendicular to the axial direction tends to be higher than that of a heat-generating layer formed by applying a resin composition in a direction parallel to the axial direction. It is believed that this is because the needle-like electrically conductive fillers are oriented in a coating direction during coating, and the electrical resistance in the coating direction is thereby reduced. Referring to the results in more detail, with an increase in the mixing ratio of the carbon nanotube, which had a higher aspect ratio, the difference in electrical resistance between the case of perpendicular coating and the case of parallel coating increased.

### INDUSTRIAL APPLICABILITY

As described above, the self-heat-generating fixing roller has a simple structure and good durability, and can be easily produced. Thus, the self-heat-generating fixing roller can be suitably used as a fixing roller of a fixing device for an image-forming apparatus.

### REFERENCE SIGNS LIST

self-heat-generating fixing roller 2 core bar 3 heat-insulating layer 4 heat-generating layer 5 mold-releasing layer 6 primer layer 7 equipotential electrode 11 pressure roller A transfer-receiving material B unfixed toner C fixed toner

1: A self-heat-generating fixing roller comprising:
a columnar core bar;
a heat-insulating layer stacked on an outer circumferential side of the core bar;
a heat-generating layer stacked on an outer circumferential side of the heat-insulating layer and heated by supplying electricity; and
a mold-releasing layer stacked on an outer circumferential side of the heat-generating layer.

2: The self-heat-generating fixing roller according to claim 1, wherein the heat-insulating layer contains a matrix containing a synthetic resin or rubber as a main component, and a plurality of pores contained in the matrix.

3: The self-heat-generating fixing roller according to claim 1, wherein the heat-generating layer contains a matrix containing a synthetic resin or rubber as a main component, and a plurality of electrically conductive fillers contained in the matrix.

4: The self-heat-generating fixing roller according to claim 3, wherein the electrically conductive fillers are a mixture of a metal powder and a carbon powder.

5: The self-heat-generating fixing roller according to claim 3, wherein the heat-generating layer further contains an insulating filler in the matrix.

6: The self-heat-generating fixing roller according to claim 3, wherein the electrically conductive fillers have a needle-like shape.

7: The self-heat-generating fixing roller according to claim 1, wherein an electrical resistance between two ends of the heat-generating layer is 5Ω or more and 100Ω or less.

8: The self-heat-generating fixing roller according to claim 1, wherein the mold-releasing layer contains a fluororesin as a main component.

9: The self-heat-generating fixing roller according to claim 1, further comprising a pair of cylindrical equipotential electrodes that are in contact with two end portions of the heat-generating layer.

10: The self-heat-generating fixing roller according to claim 1, comprising an elastic layer between the heat-generating layer and the mold-releasing layer.
